(19) United States
(12) Patent Application Publication
(10) Pub. No.: US 2004/0192505 A1
(43) Pub. Date: Sep. 30, 2004

(54) Method for the operation of a drive train for powering a mobile vehicle

(76) Inventors: Fritz Leber, Friedrichshafen (DE); Jurgen Legner, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/798,173

(22) Filed: Mar. 11, 2004

(30) Foreign Application Priority Data
Mar. 28, 2003 (DE) 103 14 337.8

(51) Int. Cl. F16H 47/08; B60K 41/02

(52) U.S. Cl. 477/169; 477/173

(57) ABSTRACT

A mobile vehicle is to be operated at constant speed, during which the speed of the drive engine, which drives a step-down transmission (5) via a hydrodynamic torque converter, varies. To do this, a clutch (2) arranged, between the drive engine and the pump impeller (3), is regulated in such manner that the actual speed of the vehicle corresponds to the specified speed.

The invention relates to a method for the operation of a drive train, according to the type defined in more detail in the preamble of claim 1.

Drive trains of this type are preferably found in working machines such as stackers, tele-handlers or graders. Particularly in the case of stackers, tele-handlers or graders, it is necessary to keep to a constant driving speed preselected by the driver. Likewise, the traction force of the vehicle has to be limited. In working machines, a drive engine powers, on the one hand the propulsion drive via a hydrodynamic torque converter and, on the other hand, an auxiliary drive for the working hydraulic system, for example. If the working hydraulic system needs more power, the speed of the drive engine is often increased, this changes the operating conditions of the hydrodynamic torque converter. In turn, this makes it more difficult for the vehicle to be held to a constant driving speed.

DE 195 21 458 A1 discloses an electrohydraulic control device for the drive system of a machine. In this, the driver has a first pedal with which he can increase the speed of the drive engine, and a second pedal with which he can bring a clutch located between the drive engine and a pump impeller of the hydrodynamic torque converter to a slipping condition. To now produce sufficient engine speed for the working hydraulic system, on the one hand, the pedal for the speed of the drive engine is actuated, and in order simultaneously to reduce the speed of the vehicle, the pedal for disengaging the clutch between the drive engine and the pump impeller is pressed at the same time. It is almost impossible to maintain a constant driving speed.

The purpose of the present invention is to provide means for maintaining a constant driving speed in a vehicle with a hydrodynamic torque converter and an auxiliary drive.

This objective is achieved by a method for the operation of the drive train, which also embodies the characterizing features of the principal claim.

According to the invention, a clutch is located between the drive engine and the pump impeller of the hydrodynamic torque converter. This clutch can be arranged within the hydrodynamic torque converter or separately, before or after it. Additionally, the drive engine powers at least one auxiliary drive, preferably formed as a hydraulic pump. The clutch between the drive engine and the pump impeller is controlled in such a manner that, regardless of the speed of the drive engine, the actual speed of the mobile vehicle corresponds to a preselected speed. For this, it is preferable for speed sensors to be arranged on the drive input or drive output of the speed-change transmission positioned on the output side of the hydrodynamic torque converter, or on drive shafts or on the vehicle's wheels, from whose signals an electronic control unit determines the actual driving speed. This actual driving speed is compared with a nominal driving speed, for example, determined by the electronic control unit from a signal from a driving pedal. The clutch between the drive engine and the pump impeller is then regulated in such a manner that the actual speed corresponds to the specified speed. During this, the speed of the drive engine can be controlled directly as a function of the demand of the auxiliary drive. For example, this can be done by causing the electronic control unit to regulate the engine with the electronic control unit generating its control signal from signals coming, for example, from the control elements of the working hydraulic system. This enables the vehicle to be operated at a constant driving speed while providing variable drive speeds for the working hydraulic system.

In a further embodiment, it is possible to limit the traction force of the vehicle, so that when the driving resistance is too high the vehicle wheels do not dig into the undersoil. This is very important, particularly with graders. Preferably, the limiting of traction force and also torque is achieved by regulating the clutch between the drive engine and the pump impeller so that regardless of the drive engine speed, an actual torque of the turbine rotor of the hydrodynamic torque converter does not exceed a predefined specified torque. For example, the torque of the turbine rotor can be determined by torque sensors on the turbine rotor or on components connected after it. It is also possible, however, to determine the torque by computation, for which the drive output speed of the hydrodynamic torque converter and the drive input speed of the hydrodynamic torque converter as well as the speed of the pump impeller are taken into account. Particularly by determining or measuring the speed of the pump impeller, the torque can be determined exactly from the performance characteristic of the converter.

If the driving speed is to be kept constant and the vehicle is on a descending slope and is consequently being operated in the thrust mode, the service brakes of the vehicle can also be actuated automatically.

If the clutch between the drive engine and the pump impeller is located inside the converter housing and if this clutch is actuated by a piston, then the piston will be acted upon, on the one hand, by the actuation force and on the other hand, by the internal pressure of the converter. To enable the clutch to be operated accurately in slipping mode and thus to be able to adjust the actuation pressure optimally, the converter's internal pressure is taken into account when determining the actuation pressure. For example, the converter's internal pressure can be determined by a pressure sensor or from the operating condition of the hydrodynamic torque converter. Preferably, the actuation pressure for the primary clutch can be adjusted by the electronic control unit via a proportional valve.

The converter's internal pressure depends essentially on the rotation speeds of the pump and turbine, the oil temperature and the amount of oil flowing through the converter. In addition, the converter's internal pressure is also determined by the opening characteristics of the valves before and after the converter. The through-flow resistances also present in the converter circuit, such as in the cooler and oil ducts, must be determined individually for every vehicle installation. The oil temperature can be measured by a temperature sensor.

The oil flow through the converter is usually propelled by a gear pump with constant displacement volume. This gear pump is usually driven at the speed of the combustion engine. The oil flow can be determined by computation from that speed.

Other characteristics emerge from the description of the figures, which show:

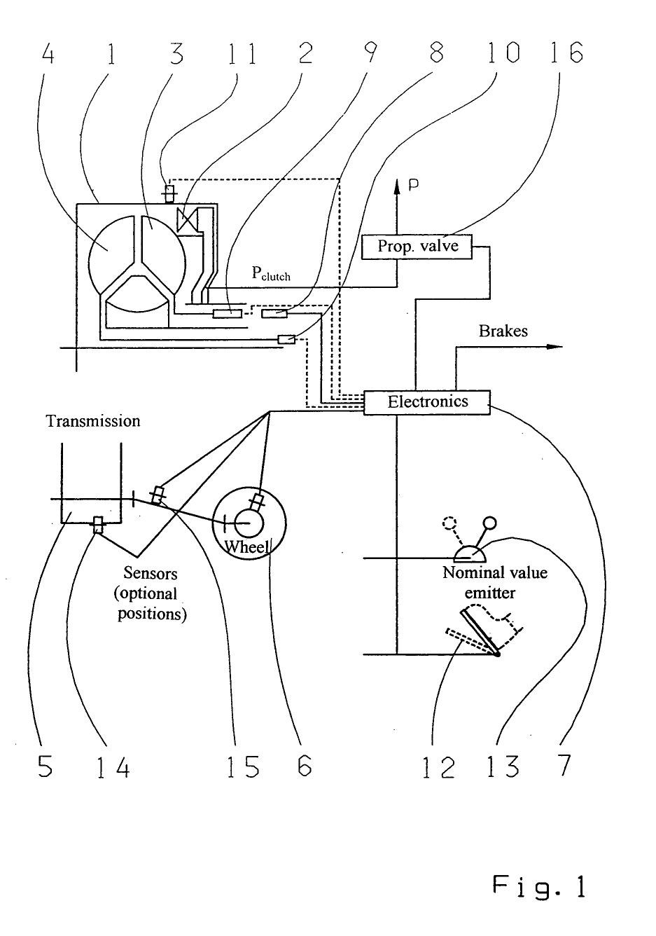

FIG. 1 shows a schematically, the structure of part of the drive train;

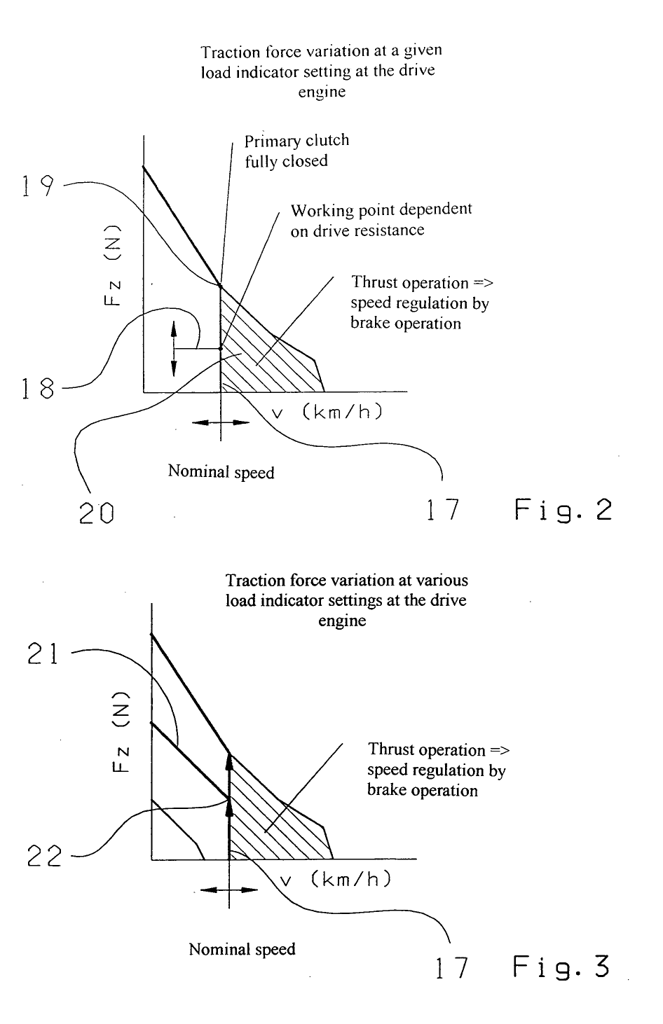

FIG. 2 shows a traction-force/speed diagram during operation at constant speed;

FIG. 3 shows a traction-force/speed diagram during operation at constant speed, for various load settings of the drive engine;

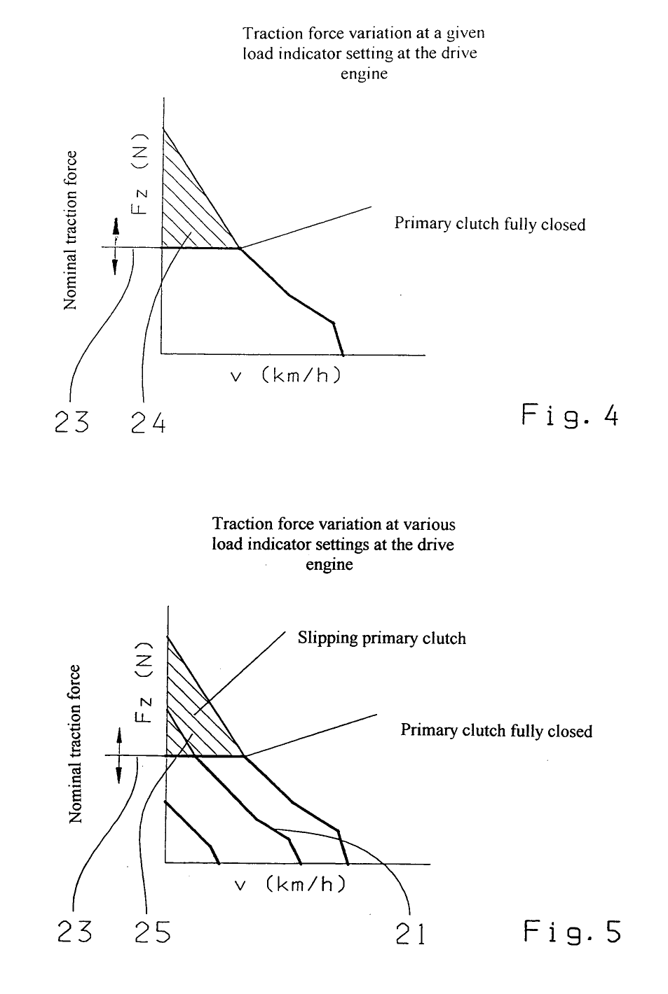

FIG. 4 shows a traction-force/speed diagram at constant traction force; and

FIG. 5 shows a traction-force/speed diagram at constant traction force and various load settings of the drive engine.

FIG. 1

A drive engine (not shown) drives a converter housing 1. The drive engine is connected to an auxiliary drive (not shown), preferably a hydraulic pump. When actuated, a clutch 2 connects a pump impeller of the hydrodynamic torque converter. When rotating, the pump impeller drives a turbine rotor 4 which is connected by a connection (not shown) to a change-under-load transmission 5, which it drives. The change-under-load transmission 5 drives drive-wheels 6. An electronic control unit 7 determines the condition of the drive train by virtue of a pressure sensor 8 and/or a speed sensor 9 and/or a speed sensor 10 and/or a speed sensor 11 and by virtue of a sensor on a driving pedal 12 and a sensor on the control lever 13 of the working hydraulic system and/or a speed sensor 14 on the transmission and/or a speed sensor 15 on the drive shaft between the transmission 5 and the drive wheel 6. In particular, when the clutch 2 is slipping, the pressure in the converter housing 1 and the torque of the turbine rotor 4 are important. By knowing the speed of the pump impeller 3 and knowing a rotation speed of the turbine rotor 4 or that of components connected after it in the drive train, as well as other operating parameters of the converter, the torque of the turbine rotor 4 and the pressure inside the converter housing 1 can be determined by computation. When the driver specifies a speed by means of the driving pedal 12 and, at the same time, actuates the control lever 13, the drive engine is adjusted in such a manner that the auxiliary drive produces enough power for the working hydraulic system while, at the same time, the clutch 2 is actuated in such manner that the vehicle moves at the desired, specified speed. To control the clutch 2, the electronic control unit 7 emits a signal to a proportional valve 16, which already takes account of the internal pressure in the converter housing 1, such that the proportional valve 16 applies pressure to the actuation device of the clutch 2.

FIG. 2

If the driver sets a speed 17 which is to be maintained constant, then a traction force 18 is established which depends on the driving resistance, since the clutch, between the drive engine and the pump impeller, will be open to a greater or lesser extent. At point 19, the clutch is completely closed. If the vehicle is moving in zone 20, because it is on a descending slope, the constant speed can be maintained by actuating the service brakes.

FIG. 3

The vehicle is at the constant speed 17, and the clutch between the drive engine and the pump impeller of the hydrodynamic torque converter is actuated in accordance with the traction force (FZ) required. In the case of a medium load indicator setting 21 of the drive engine, the vehicle maintains its constant speed 17 until a point 22 and then reduces the driving speed along the performance line of the medium load indicator setting 21. This closes the clutch between the drive engine and the pump impeller 3.

FIG. 4

A preselected maximum traction force 23 limits the traction force of the propulsion drive. In zone 24, the clutch between the drive engine and the pump impeller is regulated in such a manner that a maximum traction force 23 is not exceeded. The excess power is available for the auxiliary drive.

FIG. 5:

The performance line at medium load indicator setting 21 and the specification of the maximum traction force 23 delimit a zone 25 within which the clutch, between the drive engine and the pump impeller, is actuated in such manner that the maximum traction force 23 is not exceeded. The excess power is available for the auxiliary drive.

### Reference Numerals

1 Converter housing

2 Clutch

3 Pump impeller

4 Turbine rotor

5 Change-under-load transmission

6 Drive wheels

7 Electronic control unit

8 Pressure sensor

9 Rotation speed sensor

10 Rotation speed sensor

11 Rotation speed sensor

12 Driving pedal

13 Control lever

14 Rotation speed sensor

15 Rotation speed sensor

16 Proportional valve

17 Speed

18 Traction force

19 Point

20 Zone

21 Medium load indicator setting

22 Point

23 Maximum traction force

24 Zone

25 Zone

ZF Traction force

1-11. (CANCELED)

12. A method for the operation of a drive train for powering a mobile vehicle with a drive engine which, on the one hand, via a hydrodynamic torque converter with a pump impeller (3) and a turbine rotor (4), powers a speed-change step-down transmission (5) for driving the propulsion drive and, on the other hand, powers an auxiliary drive for driving at least one hydraulic pump, such that the pump impeller (3) can be connected via a clutch (2) to the drive engine and the turbine rotor (4) is connected to the step-down transmission (5), wherein the clutch (2) is regulated in such a manner that regardless of drive engine speed, an actual speed of the mobile vehicle corresponds to a specified speed.

13. A method for the operation of a drive train for driving a mobile vehicle with a drive engine which, on one hand, via a hydrodynamic torque converter with a pump impeller (3) and a turbine rotor (4), powers a speed-change step-down transmission (5) for driving a propulsion drive and, on another hand, powers an auxiliary drive for driving at least one hydraulic pump, such that the pump impeller (3) can be connected via a clutch (2) to the drive engine, wherein the clutch (2) is regulated in such a manner that regardless of drive engine speed, an actual torque of the turbine rotor (4) does not exceed a predefined, specified torque.

14. The method for the operation of a drive train according to claim 12, wherein in thrust operation a service brake is actuated when the specified speed is exceeded.

15. The method for the operation of a drive train according to claim 12, wherein the service brake is actuated in such a manner that the actual speed corresponds to the specified speed.

16. The method for the operation of a drive train according to claim 12, wherein the clutch (2) is regulated as a function of the speed of the drive engine and the difference between the actual speed and the specified speed.

17. The method for the operation of a drive train according to claim 13, wherein the clutch (2) is regulated as a function of the speed of the drive engine and the difference between the actual torque and the specified torque.

18. The method for the operation of a drive train according to claim 12, wherein the clutch (2) is located inside a converter housing (1) and is cooled by a liquid present therein.

19. The method for the operation of a drive train according to claim 12, wherein a speed can be specified by means of a driving pedal (12).

20. The method for the operation of a drive train according to claim 12, wherein the clutch (2) can be actuated by an electronic control unit (7) and a proportional valve (16).

21. The method for the operation of a drive train according to claims 12, wherein the clutch (2) is actuated by an actuation pressure which is adjusted as a function of an actual pressure inside a converter housing (1).

22. The method for the operation of a drive train according to claims 12, wherein the clutch 2 is located outside a converter housing (1) and is cooled by a coolant liquid.
